(19) United States
(12) Patent Application Publication
(10) Pub. No.: US 2006/0218450 A1
(43) Pub. Date: Sep. 28, 2006

(54) Computer system performance analysis

(76) Inventors: Shakiel Malik, Berkshire (GB); Keith Halewwod, Hildenborough, Kent (GB)

Correspondence Address: OBER / KALER;c/o Royal W. Craig, 120 East Baltimore Street, Baltimore, MD, 21202, US

(21) Appl. No.: 10/537,922

(22) PCT Filed: Dec. 6, 2002
(86) PCT No.: PCT/GB02/05515

§ 371 Date: Feb. 7, 2006

(51) Int. Cl. G06F 15/00

(52) U.S. Cl. 714/47; 702/186

(57) ABSTRACT

A method and apparatus is disclosed where a web server (10) has its performance measured by performance data being sent, via the Internet or by similar means, to an analyzer (12) with a relational database management system (14) and a data storage database (16). The analyzer (12) analyses the performance of the web server (10) per se, and/or with reference to previous instances of analysis, and/or with reference to the results of analysis of performance data from other, similar computer systems, and/or with reference to manufacturers, vendors or suppliers data. The analyzer can generate one or other, or both of a humanly readable report, in the form of problems and solutions, and an instruction set of instructions to provide the solutions. The report is sent back to the web server (10) site to be acted upon by an end user. 'the instruction set can also be sent back to the web server (10), for the web server automatically to apply the solutions or under approval from the end user.

The present invention relates to computer system server performance analysis and consequent enhancement of performance.

The focus of any commercial enterprise, particularly in relation to its Information Technology (IT) infrastructure is in using IT to solve business-related problems. Problems and solutions are at the application/middle-ware (both being program elements which operate or co-operate with an operating system) end which is where most in-house expertise lies. Businesses rely on computer vendors for performance-capable systems on which their systems will run but the biggest and best systems are not necessarily in harmony with IT budgets nor with future capacity planning.

Current performance analysis tools on the market do not answer questions related to perceived problems, merely presenting operating system and middleware measured operational statistics in graphical format or providing alarms when preset thresholds (requiring expertise) are exceeded. As in-house commercial expertise usually focuses on higher-level applications and middleware such as Relational Database Management Systems (RDBMS), when there are perceived performance problems, an external (and expensive) performance consultant is often required to gather operating statistics over a period of days, perform an audit of hardware and software running on the system or servers, analyse the running statistics relating application software problems to the operating system and hardware, and compose a report in problem and solution format, with attendant graphs and supporting material. The cost associated with even the briefest of consultations may exceed that of a major component cost of a company's IT infrastructure, or even that of a budget. Consequently, there is a need for an inexpensive, automated system that can gather and analyse performance metrics from a server and deliver easily comprehensible problem determinations and provide solution information.

To overcome the cost-centred limitations in the prior art described above and to overcome other limitations that the traditional sale, licensing and maintenance of performance analysing software would impart, the present invention seeks to provide a method and apparatus by which the end-user may engage in timely, efficient, easily comprehensible performance analysis without necessarily being conversant with any analysis techniques.

The present invention further seeks to provide a method and apparatus where the target computer server has the option of enabling automated corrective action to be taken by providing computer instructions to be issued and obeyed which implement the solution, thus achieving an immediate performance gain automatically to achieve a technical effect in the form of a technical enhancement of the performance of the analysed system.

According to a first aspect, the present invention consists in a method for analysis of performance of a target computer system, said method including the steps of: recording performance data from said target computer system; sending said recorded performance data to a remote analyser; said analyser analysing said recorded performance data; said analyser, in response to the content of said performance data, generating and providing a humanly readable report; and said analyser sending said humanly readable report back to said target computer system (or nominated alternative.

According to a second aspect, the present invention consists in an apparatus for analysis of performance of a target computer system, said apparatus comprising: recording means, operative to record performance data sent from said target computer system to a remote analyser; said analyser being operative to analyse said recorded performance data; said analyser being operative, in response to the content of said performance data, to generate and provide a humanly readable report; and said analyser being operative to send said humanly readable report back to said target computer system or nominated alternative).

The invention further provides that the humanly readable report can comprise problems and potential solutions thereto.

The invention also provides that the analyser can further produce and send to said target computer system, an instruction set, for use at said computer system, said instruction set being operative to cause said target computer system automatically to apply said solutions.

The invention further provides that each solution from said instruction set can be applicable conditionally upon approval by an end user.

The invention further comprises that said analyser is operative to analyse said performance data with respect to performance data gathered on one or more previous instances of analysis of performance data from said target computer system.

The invention further provides that said target computer system can be in addition to a plurality of similarly analysed and reported computer systems which are analysed by said analyser, and that said analyser can be operative to analyse said performance data with respect to performance data from one or more of said plurality of similarly analysed and reported computer systems.

The invention further provides that said one or more of said plurality of similarly analysed and reported computer systems are similarly configured to said target computer system.

The invention further provides that said analyser can be operative to analyse said performance data with respect to performance data provided by one or more equipment or software manufacturers.

The invention further provides that said analyser can be operative to analyse said performance data with respect to performance data provided by one or more equipment or software vendors or suppliers.

The invention further provides that communication can be through the Internet, by cable, by satellite, or by private network.

The invention further provides that said analyser can send a performance data gathering routine to said target computer system, said performance data gathering routine being operative to gather performance data from said target computer system.

The present invention discloses a mechanism and method by which an end-user may transport system server performance metrics to a web-enabled, automated performance analysis interpreter, which will then generate a series of reports, retrievable by electronic mail and/or interactive reports presented via a web browser. The system may also generate scripted, automated corrective action which may be executed by the target system which has been analysed.

The present invention further seeks to provide a method and apparatus capable of delivering a range of graded reports over, for example, the Internet, or a private network, ranging from easily understood business-level problem and solution reports, to fully specific technical reports.

The present invention is further described, by way of example, by the following description, to be read in conjunction with the appended drawings, in which:

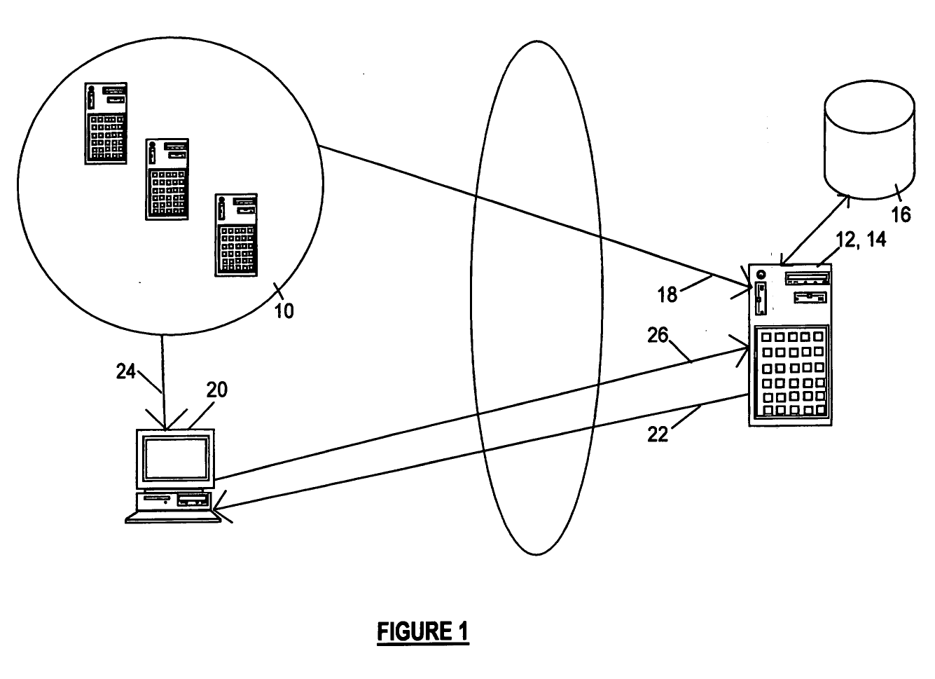

FIG. 1 is a schematic diagram showing an example of a computer system and analyser and helps illustrate the interaction there-between.

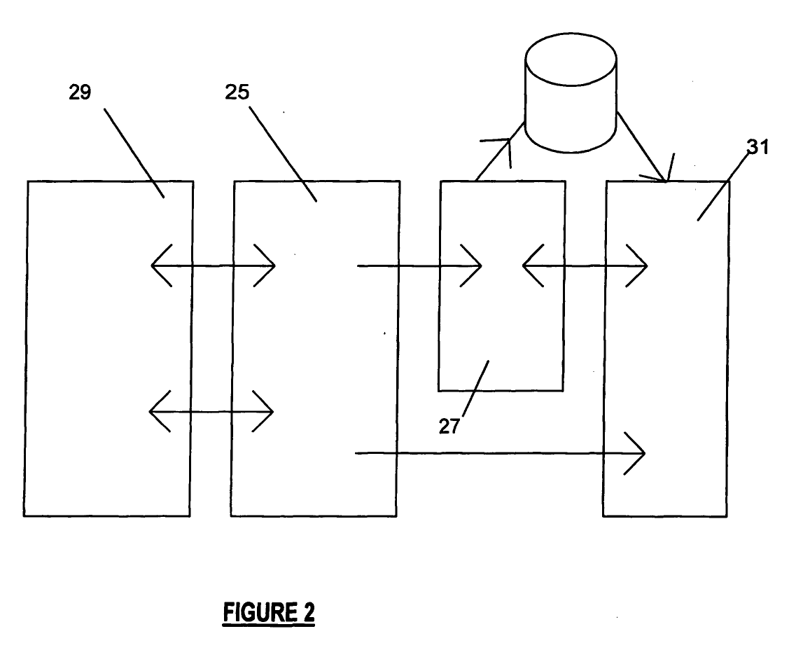

FIG. 2 is a schematic diagram showing the architecture and dataflow within the analysed computer system.

And

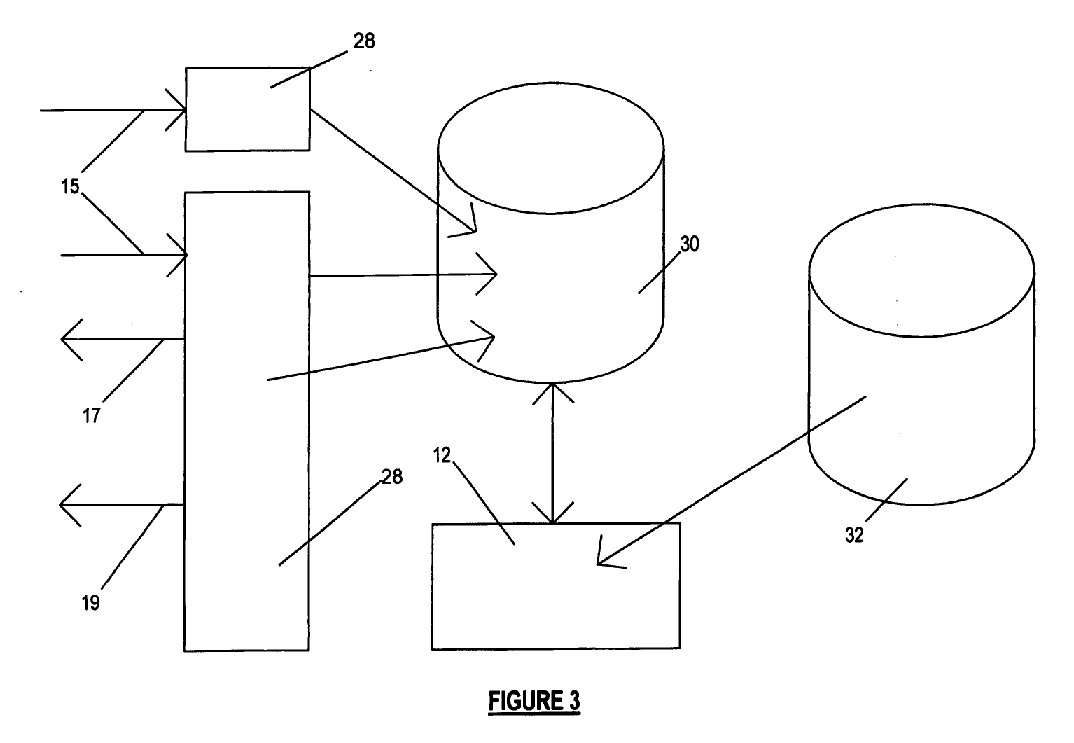

FIG. 3 is a block diagram showing an example of the various elements and their inter relationship in the analyser.

Attention is first drawn to FIG. 1, showing a schematic diagram of the various elements involved in the operation of the present invention and their interactions with one another.

An e-commerce system is built around an end user site in the form, in this example, of a web server 10. A performance analysis interpreter 12 and a relational database management system 14, which has access to a data storage database 16, are used to interpret data from the web server 10. Performance analysis statistics are uploaded from the web server 10, as indicated by arrow 18, and stored in the database 16 against the user's previously registered system details which may also be rediscovered or verified against the current data set being uploaded.

Data transfer, in this example, is via the Internet. It is to be appreciated that the present invention also encompasses data transfer by any means, or combination of means, including, but not limited to, private networks, satellite, and cable.

The performance analysis interpreter (PAI) 12 analyses the performance data received from the web server 10 and prepares a multi-level report which is lodged into the database 16. The end-user may interact the PAI 12 and the web server 10 via the end user's workstation or browser 20. The end user can receive the report from the PAI 12 as indicated by arrow 22. The end user can download the performance data from the web server 10 and can send that data to the PAI 10, as indicated by arrows 24, 26. The end user can interact with the report, discovering recommended solutions to perceived problems or reviewing spare-capacity information. In the case where dynamic configuration changes have been indicated, the end user may download a humanly readable copy of the change procedure for manual execution on the web server 10 under test. Equally, the end user can arrange for the web server 10 under test to download and execute the change procedure automatically, so effecting the recommended solution without further user intervention. The downloaded change procedure can be already in the form of machine instructions to be obeyed, or can be converted into such instructions on receipt to alter the operating parameters of the devices and resources within the tested web server 10 so that better operation is achieved.

There are two main tiers of application strata. The first tier comprises the end-user environment 10 20. The second tier comprises the central analysis and storage environment 12, 14, 16.

Attention is next drawn to FIG. 2, showing for example, the various elements in the end user site, which, in this example, comprises the web server 10 of FIG. 1.

The end-user environment 10 20 consists of one or more computer system ‘servers’ 10 running a range of supported operating systems 25 such as, but not limited to, UNIX (which can be any one of HP-UX, Solaris, AIX, Linux, True64), Novell Netware or Windows NT/2000 which are to be analyzed for performance measurement purposes. The operating system 25 can be any present or future operating system 25 capable of analysis for performance, or capable of receiving and causing to operate a performance data gathering routine operative to analyze performance and operative to send, or to provide for sending, the performance data to the PAI 12.

A performance data collecting program or routine, in the form of a System Information (SI) data collection agent 27 is downloaded from the central system 12 14 16 that interacts with a similarly supplied generic performance data gathering routine or with one already resident within the user system's 10 operating system 25. The operating system's 25 gathered performance data is derived from the operating system's 25 interaction with the applications and middleware 29 which are enabled by and supported by the operating system 25. The gathered performance data is collated and communicated by a data collection agent 31.

Generic performance data gathering routines gatherers typically report a snapshot of global performance counters at fixed time intervals as well as per instance of use for such things as an application process, disc resources, communications resources, networking interface, processor, and any other element, process or utility used by the system under test, the values of the performance counters changing as resource usage occurs. A data collection agent is a collating and transmitting routine for configuring and monitoring the performance data gathering routine, taking a snapshot of current hardware and operating system configuration data and coordinating this data upload through Internet channels (http or smtp) either on end-user 20 demand or by automated schedules, to the PAI 12 and its associated equipment 14 16. The data collection agent is also operable to compressing messages bearing collected performance data and is further operable to providing encryption and decryption to messages for use where the end-user requires message privacy.

Attention is drawn to FIG. 3, showing the various parts of the central performance analysis facility 12 14 16.

The central performance analysis facility 12 14 16 consists, in this example, of one or more Unix-based servers 28 providing an e-commerce enabled web application, which permits the end-user 20 to upload performance metric data sets under the control of the data collection agent from the end-user's systems 10, initiate the performance analysis interpreter (PAI) 12 to transform uploaded data sets into multi-level interactive reports, and browse generated reports or request e-mail summaries be delivered.

The web server 28 e-commerce application, in this example, is based on Apache running on a Unix platform with Perl programming environment integrated into the httpd servers. Other options are possible, which will be apparent to the person, skilled in the art.

The web server or servers 28 can receive performance data as indicated by arrows 15, can send out a humanly readable report as indicated by arrow 17, and can send out solution instruction sets as indicated by arrow 19.

The Performance Analysis Interpreter (PAI) 12 is itself written in Perl with interface modules to a local Relational Database Management System (RDMS) 30 from which it retrieves the SI performance data set to be analyzed, previous SI result sets from the same target system, and is operative to acquire related SI data sets and result sets from other similar systems (those with similar application profiles) and is further operative to acquire and hardware/software vendor supplied performance profiles from one or more vendor Relational Database Management Systems (RDBMS) 32.

The PAI 12 uses classical performance analysis methods to determine where and when the system under analysis 10 has been exhibiting poor performance and/or excessive resource usage with respect to hardware capacity, installed resources, patterns of resource usage and previous observed behavior on the same or similar systems already in the database.

Once bottlenecks have been identified, the PAI identifies culprits or the processes which comprise all or specific parts of the application being executed by the system under analysis.

For each type of bottleneck, particularly those being exhibited either concurrently or most recently, the PAI 12 gauges the effect of each bottleneck on the others to determine the effect should its impact be negated. After this analysis, surviving bottlenecks and their attendant culprit lists are used to generate potential solution lists, which form the basis of the top level, solution-orientated reports. The entire determination data structures are used to form the basis of the technical, navigable reports.

The PAI 12 generates daily, weekly and monthly reports (depending upon the request by the user) from the data that is held in the SI developed repositories.

In essence, the PAI 12 interprets technical operating system measured performance data into a human comprehensible language (HCL), preferably, but not necessarily, English.

The above describes an architecture, method and mechanism by which systems performance analysis and enhancement may be made automatic and efficient, capable of rendering performance data as a series of human-readable problem and solution reports.

As previously stated, the present invention also provides for automated application of the solution or solutions proposed by the problem and solution reports. The PAI (12) can reduce the content of the problem and solution report to a modification instruction set which can be sent to the end user's browser 20 for staged, optional application by the end user to the web server 10, or directly to the web server 10 for automatic application by the web server 10, to modify the working parameters, message routing and resource allocation, to name but a few aspects of the web server 10, towards the web server 10 providing an improved performance.

Apart from the technology within the performance analysis interpreter (PAI) 12, the centralized approach to performance analysis negates the need for the traditional cycle of analysis software sales and licensing, and more importantly, maintenance. End-users will always be analysing their systems using the latest analysis engine, supported by the latest hardware/software vendor information combined with the results of other analyses and automated quality assurance checks and procedures.

1. A method for analysing performance of a target computer system, said method including the steps of:
recording performance data from said target computer system;
sending said recorded performance data to a remote analyser;
said analyser analysing said recorded performance data;
said analyser, in response to the content of said performance data, generating and providing a humanly readable report; and
said analyser sending said humanly readable report to at least one of said target computer system and a nominated alternative.

2. A method, according to claim 1, wherein said humanly readable report comprise observed problems and potential solutions thereto.

3. A method, according to claim 1, including the further steps of:
said analyser producing an instruction set, for use at said computer system, said instruction set being operative to cause said target computer system automatically to apply said solutions; and
said analyser sending said instruction set to said target computer system.

4. A method, according to claim 3, including the step of causing each solution from said instruction set to be applicable to said target computer system conditionally upon approval by an end user.

5. A method, according to claim 1, wherein said step of said analyser analysing said performance data includes the step of said analyser analysing said performance data with respect to performance data gathered on one or more previous instances of analysis of performance data from said target computer system.

6. A method, according to claim 1, wherein said target computer system is in addition to a plurality of similarly analysed and reported computer systems which are analysed by said analyser; and wherein said step of said analyser analysing said performance data includes the step of said analyser analysing said performance data with respect to performance data from one or more of said plurality of similarly analysed and reported computer systems.

7. A method, according to claim 6, wherein said one or more of said plurality of similarly analysed and reported computer systems are similarly configured to said target computer system.

8. A method, according to claim 1, wherein said step of said analyser analysing said performance data involves the step of said analyser analysing said performance data with respect to performance data provided by one or more equipment or software manufacturers.

9. A method, according to claim 1, wherein said step of said analyser analysing said performance data involves the step of said analyser analysing said performance data with respect to performance data provided by one or more equipment or software vendors or suppliers.

10. A method, according to claim 1, wherein said step of sending said recorded performance data to said remote analyser involves using at least one of the Internet, cable, satellite, and private network.

11. A method, according to claim 1, wherein said step of sending said humanly readable report back to said target computer system, involves using at least one of the Internet, cable, satellite, and private network.

12. A method, according to claim 1, including the step of said analyser sending a performance data gathering routine to said target computer system, said performance data gathering routine being operative to gather performance data from said target computer system.

13. An apparatus for analysis of performance of a target computer system, said apparatus comprising:
receiving means, operative to receive recorded performance data sent from said target computer system; and
a remote analyser in communication with said receiving means and operative to analyse said recorded performance data;
said analyser being operative, in response to the content of said performance data, to generate and provide a humanly readable report;
and said analyser being operative to send said humanly readable report back to at least one of said target computer system and a nominated alternative.

14. An apparatus, according to claim 13, wherein said humanly readable report comprise observed problems and potential solutions thereto.

15. An apparatus, according to claim 13, wherein said analyser is operative to produce an instruction set, for use at said computer system, said instruction set being operative to cause said target computer system automatically to apply said solutions;
and said analyser being operative to send said instruction set to said target computer system.

16. An apparatus, according to claim 15, wherein each solution from said instruction set is applicable to said target computer system conditionally upon approval by an end user.

17. An apparatus, according to claim 13, wherein said analyser is operative to analyse said performance data with respect to performance data gathered on one or more previous instances of analysis of performance data from said target computer system.

18. An apparatus, according to claim 13, wherein said target computer system is in addition to a plurality of similarly analysed and reported computer systems which are analysed by said analyser; and wherein said analyser is operative to analyse said performance data with respect to performance data from one or more of said plurality of similarly analysed and reported computer systems.

19. An apparatus, according to claim 18, wherein said one or more of said plurality of similarly analysed and reported computer systems are similarly configured to said target computer system.

20. An apparatus, according to claim 13, wherein said analyser is operative to analyse said performance data with respect to performance data provided by one or more equipment or software manufacturers.

21. An apparatus, according to claim 13, wherein said analyser is operative to analyse said performance data with respect to performance data provided by one or more equipment or software vendors or suppliers.

22. An apparatus, according to claim 13, wherein said receiving means is operative to receive said recorded performance data using at least one of the Internet, cable, satellite, and private network.

23. An apparatus, according to claim 22, wherein said analyser is operative to send said humanly readable report back to said target computer system using at least one of the Internet, cable, satellite, and private network.

24. An apparatus, according to claim 13, wherein said analyser is operative to send a performance data gathering routine to said target computer system, said performance data gathering routine being operative to gather performance data from said target computer system.

25. An apparatus, according to claim 15, wherein said analyser is operative to send said instruction set back to said target computer system using at least one of the Internet, cable, satellite, and private network.

26. A method, according to claim 3, including the step of said analyser sending said instruction set back to said target computer system using at least one of the Internet, cable, satellite, and private network.

27. A method for analysing performance of a target computer system, said method including the steps of:
recording performance data from said target computer system;
sending said recorded performance data to a remote analyser;
said analyser analysing said recorded performance data;
said analyser, in response to the content of said performance data, producing an instruction set, for use at said computer system, said instruction set being operative to cause said target computer system automatically to apply said solutions;
and said analyser sending said instruction set to said target computer system.

28. A method, according to claim 27, including the step of causing each solution from said instruction set to be applicable to said target computer system conditionally upon approval by an end user.

29. An apparatus for analysis of performance of a target computer system, said apparatus comprising:
a remote analyser;
receiving means, operative to receive recorded performance data sent from said target computer system to a remote analyser;
said analyser being operative to analyse said recorded performance data;
said analyser being operative, in response to the content of said performance data, to produce an instruction set, for use at said computer system, said instruction set being operative to cause said target computer system automatically to apply said solutions;
and said analyser being operative to send said instruction set to said target computer system.

30. An apparatus, according to claim 29, wherein each solution from said instruction set is applicable to said target computer system conditionally upon approval by an end user.
